(19) United States
(12) Patent Application Publication
(10) Pub. No.: US 2015/0113727 A1
(43) Pub. Date: Apr. 30, 2015

(54) INTRAHOSPITAL VEHICLE FOR TRANSPORTING AND MOVING INPATIENTS

(71) Applicant: Jorge Horacio Capilla, Olavarria - Prov. de Buenos Aires (AR)

(72) Inventor: Jorge Horacio Capilla, Olavarria - Prov. de Buenos Aires (AR)

(21) Appl. No.: 14/068,392

(22) Filed: Oct. 31, 2013

(51) Int. Cl. A61G 7/10; A61G 1/02

(52) U.S. Cl. CPC A61G 7/1017; A61G 1/02; A61G 7/1046
USPC 5/87.1

(57) ABSTRACT

A vehicle conceived especially to take the hospitalized patient, generally in supine position, lift him and place him on a stretcher (C), to move him through hospital, with the ability to transfer him to a work table, of the type used at diagnostic services, or to an operating table (G), or its equivalent, without demand of effort for the nurse who drives it. It is constituted over a lower chassis (1) mounted over wheels (11), wherefrom a fixed stretcher is projected (C) and a fixed stretcher frame along which it moves, vertically, a lift cart (A) having at least a pair of parallel brackets (7) that are projected to a same side, which support the vehicle's swing (P), constituted by a longitudinal rigid pipe (12) mounted on a turning condition on the free ends of the mentioned brackets (7), of which at least two incurved arms (8) are supportive which, due to their free ends support a longitudinal rigid rod (19) wherefrom a plurality of hangers hang (14) bearing attachment means for the removable arrangement of a bed pad; the lift cart is associated to a first actuator mounted on the fixed stretcher frame, that actuates its vertical movements, controlled by a remote control; while of the mentioned incurved arms (8) is associated to a second actuator mounted on the lift cart, which activates the transversal movements of the swing, controlled by the same remote control. The lower chassis (1) comprises a lower rectangular structure with width and length such as the one of a conventional hospital stretcher; from one of its superior sides, a fixed stretcher frame is projected comprising the pair of vertical towers, joined together by an inferior crossbar (23), superior stretch (4) whereby the lift cart (A) moves, while it laterally contains a central column (3) of minor height that supports the stretcher (C). Said lift cart (A) comprises two robust boxes (5) that slide along the superior stretch (4) of both towers in a telescopic manner, with the insertion of corresponding glide runners or linear bearings (25); both bushings are joined together by the structural crossbar (6) wherefrom the respective fixed brackets (7) project oriented to a side, over the stretcher (C). Likewise the swing (P) comprises two incurved arms (8) that are articulately linked to the brackets (7) of the lift cart, which are joined together through a superior longitudinal pipe (12) and an inferior longitudinal pipe (13), configuring a structural grate of the swing. Said swing (P), holds a plurality of arched bars that constitute the hangers (14) that hang from a logiform tube (19) threaded in the holes (10) defined on the free ends of each incurved arm. Each hanger (14) comprises an arch with a circumference with a midpoint that includes a corresponding hole (16) for its bascule mounting on the mentioned logiform tube (19), each of which includes on its external free ends attachment means (15) created for mounting a bed pad (18) that receives a patient.

### SCOPE OF THE INVENTION

The main object of this invention is an INTRAHOSPITAL VEHICLE FOR TRANSPORTING AND MOVING INPATIENTS, conceived especially to take the hospitalized patient, generally in supine position, lift him and place him on a built-in stretcher, to move him through hospital, with the ability to transfer him to a work table, of the type used at diagnostic services, or to an operating table, or its equivalent, without demand of effort of the nurses or the patient himself who adopts an absolutely passive attitude upon the team performing the maneuvers for him.

More precisely, this invention protects a dragging vehicle that can be moved by a nurse as if it were a hospital stretcher, with the distinctive feature that it composes a novel system of electro mechanic equipment per se especially conceived for taking the patient who is on lay down position, lift him and place him on his transfer stretcher, without any effort, for which especial electric actuators are activated which are commanded with a remote control.

It is an electro mechanic set that works as an integrator system of movements in space in whatever position the patient is, combining lifting and lowering movements on the vertical level, combined with lateral movements on the horizontal level, necessary for transferring patients in between stretchers and its equivalents, on an accurate, sequential, silent, safe, imperceptible and therefore extremely comfortable manner for the patient, constituting a useful tool of easy handle suitable for use in any health center.

It is especially highlighted that with the invented vehicle, the need of using nurses for lifting the hospitalized patient with effort is eliminated, since they are forced to make anti ergonomic body movements that affect their own spine and waist system that causes usual pathologies and illnesses in wards at hospitals and health centers.

With the invented vehicle, the nurse only places the bed pad under the patient and introduces the handles in the existing attachments being in this way connected to the vehicle, as from then proceeds to command the lifting and transfer movements using a remote control, acting as spectator and supervisor of the maneuvers she directs.

It is an invention that defines a new combination of means and systems conceived to achieve a superior result, it being unpredictable and surprising included for an expert in the field. In consequence, besides being new, its structural and functional conception shows a clear inventive activity, thus, meeting the Law requirements to be considered a patent of invention.

### BACKGROUND

As it is known, currently most patients hospitalized in Hospitals and Health Centers, must be carried internally therein in order to access different areas of diagnosis and treatment, including mostly the surgical area.

To that end, there is the usual routine wherein the patient is looked for in his room at least by two nurses or specialized stretcher-bearer staff who, firstly proceed to place the bed pad under the body of the patient. The bed pad is a textile piece of plastic material, resistant and washable including grip handles in correspondence with its perimeter edge.

Once the patient is prepared, they proceed to bring the stretcher close, placing it adjacent to the bed and to execute the maneuvers of moving the patient until he is placed on the transfer stretcher. To do so, they follow very strict universal rules that require the presence of a nurse or stretcher-bearer on one side of the bed, another at the end and the third at the bedhead, in many cases a fourth person is included, located at the side of the stretcher, opposite to the first one. Then the nurses located on the sides bend forward, holding the handles of the bed pad, while the other two hold the head and feet of the patient.

Then somebody orders the transfer so that, jointly and in unison, the patient is lifted, laterally moved and placed on the attached stretcher, which still with the best willingness and experience results an abrupt and untimely maneuver due to the limitation of the human effort upon the weight and location of the patient to be moved.

Once the patient is placed on said stretcher, movement thereof takes place with a stretcher-bearer at the front and another at the end, which wanders from the room towards the halls and lifts until it reaches the area where the patient is subjected to a diagnosis or treatment (rays, tomography, orthopedics, etc.) or the surgery area where said maneuvers are made again to place the patient on the corresponding operating table.

Finally, once each treatment of the patient has finished he must return to his bed, therefore the same moving and transfer service as described above is required.

It can be affirmed that, until today no apparatus, devices or equipment conceived for replacing in the same manner and idiosyncrasy the maneuvers at unison made by stretcher-bearers and nurses to move inpatients are known. Only some boards are known that have perimeter handles or coach-stretchers that displace to the side a rigid conveyor belt of considerable thickness which is introduced through a crank between the bed and the patient and that after inverting the sense literally “drags” the patient towards the stretcher without lifting him and this mechanical device cannot copy at all the softness of the cradle made by the bed pad, however they do not eliminate most of the synchronization tasks or efforts needed to move the patient.

### DESCRIPTION OF THE INVENTION

### Advantages

According to the present invention, once the bed pad is placed under the patient, there must proceed to his transfer to the invented vehicle, which requires no effort whatsoever. Then the same stretcher-bearer via the remote control activates the electro mechanical devices so that, through his lift cart and pivotal arms makes the smooth synchronic movement maneuvers explained above.

In order to take the objective and function superficially stated into practice, the invented intrahospital vehicle is constituted on a lower chassis mounted over wheels of easy displacement, wherefrom a stretcher is projected that comprises a pair of vertical towers whereby a special and novel lift cart displaces, having two parallel brackets projected towards a same side.

From the free ends of the mentioned brackets the hereinafter referred to as swing is defined, constituted by a mounted longitudinal rigid pipe, on rotatory condition on corresponding bushes disposed on the free ends of said brackets, of which end incurved arms are supportive, and a central arm, equidistant therefrom, all of which constitute the arm of the swing, supportive to the abovementioned rotatory longitudinal rigid pipe.

Likewise, said incurved arms of the swing support, by its respective free ends a longitudinal rigid bar wherefrom a plurality of hangers hang with the form of a semicircunferencial arc, distinguished because, on their external free ends they have attachment means for the removable collocation of a plastic material provided to hold and contain the prostrated patient, usually called “bed pad”, which particularly in this invention extends from head to toes.

One of the mentioned incurved arms is associated to a corresponding electro mechanic actuator integrated to the command and actuation circuit of the set. In this manner from the aforementioned control remote, the stretcher-bearer shall be able to drive the displacements of lateral transfer on both directions.

The mentioned lift cart, mounted in telescopic sliding condition in respect of the referred vertical towers, is actuated by an electric actuator through which the up and down displacements of the swing are produced, while one of the referred incurved arms is associated to a second actuator through which the regulated lateral displacements are produced.

In this manner from the aforementioned control remote, the stretcher-bearer shall be able to drive the up and down displacements, combined with the lateral transfer displacements on both directions.

### INVENTIVE ACTIVITY

No intrahospital bed or equivalent equipment currently known proposes, or even suggests, the constructive solution that arises from what is indicated in the preceding paragraphs, which is why it is a proposal that, besides being novel has a clear inventive activity.

### BRIEF DESCRIPTION OF THE FIGURES

In order to fulfill the superficially aforementioned advantages, to which users and people with knowledge in the art shall be able to add many more, and in order to facilitate understanding of the constructive, constitutive and functional characteristics of the invented intrahospital vehicle, the example of a preferred embodiment will be described which is schematically illustrated and without a determined scale, in the accompanying pages, said example shall not be considered as limitative or exclusive of the scope of protection of the present patent of invention, it simply intends to merely explain and illustrate the basic conception on which it is based.

FIG. 1 is a side view that represents the invented intrahospital vehicle as a whole.

FIG. 2 is a front view of the same vehicle of the previous figure.

FIG. 3 is a detail, on a side view that shows a hanger suitable for being used in the intrahospital vehicle of this invention.

FIG. 4 is a detail of the superior plan that shows how the swing bearer of the patient that integrates the intrahospital vehicle of this invention is constituted.

FIG. 5 is a representation of the same vehicle of the previous figures on the position it adopts for the transfers.

FIG. 6 represents the same vehicles of the previous figures shown as it is positioned to dispose the patient on an operating table.

FIG. 7 represents the same vehicles of the previous figures, in this case shown as it is positioned to dispose the patient on a bed.

Clarification is made that, in all figures, same reference numerals and letters relate to the same or equivalent parts or elements that constitute the set, according to the example chosen for the present explanation of the invented intrahospital vehicle.

### DETAILED DESCRIPTION OF A PREFERRED EXAMPLE

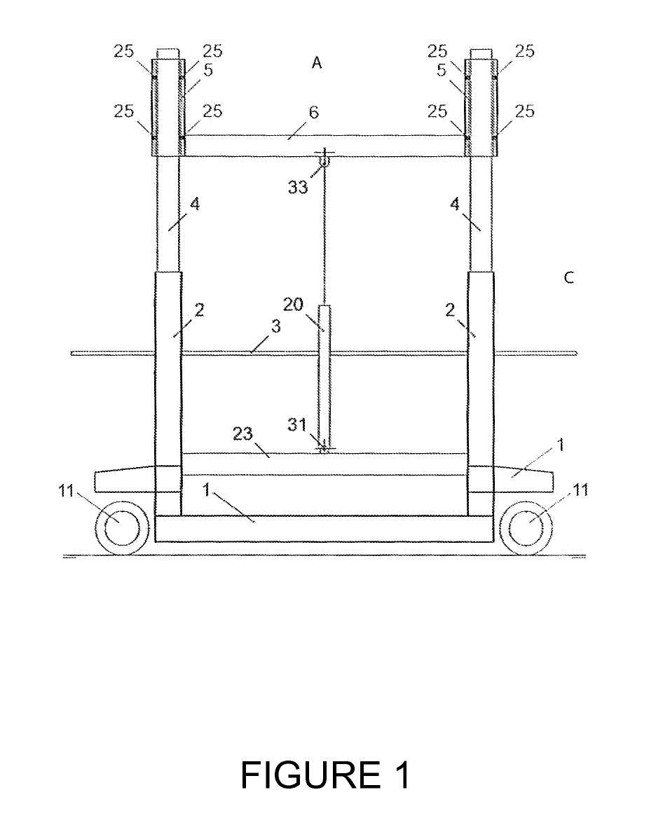

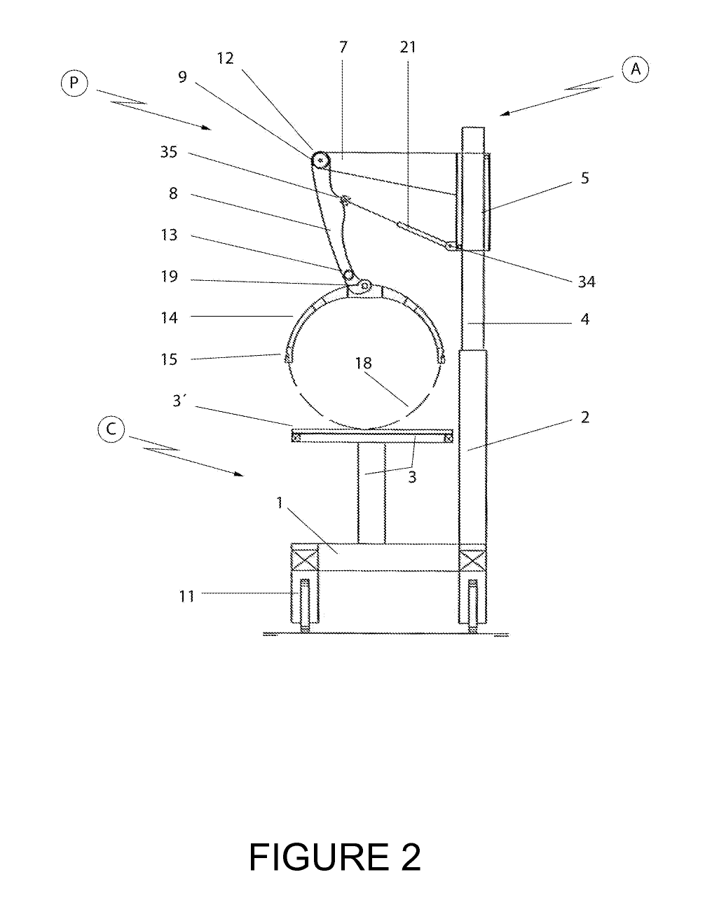

As it can be appreciated in FIGS. 1 and 2, the intrahospital vehicle for transporting and moving patients referred to in the present invention, is constituted from a lower chassis (1) mounted over wheels (11), constituted by a pair of crossbars joined by rungs in a manner that a lower rectangular structure is defined which width and length is as the one of any conventional hospital bed in such way that it may be moved along the interior of the health center, without inconvenience.

In said figures it is appreciated that, on the mentioned lower chassis, a fixed stretcher frame is constituted which comprises the pair of vertical towers (2) joined among each other by the crossbar (23), each of which is prolonged defining a superior stretch (4) of solid quadrangular section constitutive of the vertical displacement guides of the lift cart (5), while it laterally disposes a central column (3) of shorter height that supports the bed rigid and rectangular (C), preferably covered with a padding (3′).

It is clear that a strong structure is configured which has the load perfectly distributed, ensuring a great stability not only during transporting, but also when placing and transferring patients.

Especially observing FIG. 1, it is possible to understand that, mounted on the aforementioned towers (2) is the lift cart (A) that comprises two robust boxes (5) that run along the superior stretch (4) of both towers, with the insertion of corresponding displacement linear bearings (25); both boxes are joined among each other by the structural crossbar (6).

Likewise, as it is also observed in FIG. 2, from the mentioned boxes (5) of the lift cart, respective fixed brackets (7) oriented towards a side, parallel among each other and on a same superior horizontal plane, over the stretcher (C).

For the telescopic up and down displacements of the cart (A), the vehicle of this invention uses an electro mechanic actuator (20) that extends between the inferior attachment wings (31), disposed over the crossbar (23) of the fixed stretcher frame, and the wing (33) of the superior stretcher frame (6) that integrates the mentioned lift cart (A), which integrates an electronic circuit of actuation that, in preference shall be commanded via remote control.

As it is shown in FIGS. 2, 5, 6 and 7, said lift cart (A) bears a special swing (P) especially conceived to carry out the transfer tasks of the patient from and onto the stretcher (C) that integrates the vehicle of this invention.

In a preferred embodiment, this swing (P) comprises two incurved arms (8) that, by their proximal end present respective bushes (9) through which they are articulately bonded with the referred brackets (7). Likewise, those arms (8) are kept bonded among each other through the superior longitudinal pipe (12) and the inferior longitudinal pipe (13), of which are supportive configuring the structural grate of the swing wherein a third incurved arm (8′) is included equidistant from the other two (8).

The angular movements for the transversal displacements of this swing (P) are executed through the electro mechanic actuator (21) that extend from an anchor wing (34) disposed on the body of the lift cart (A), and a wing (35) defined in an intermediate point of the incurved arm (8′).

This actuator is also kept bonded to an electronic circuit that includes a means of command via remote control.

It is clarified that both actuators (20) and (21) can be dynamic fluid cylinders, pneumatic or well any other means equivalent capable of carrying out the mentioned displacements, that can be actuated through electric devices, fed with rechargeable energy accumulators and with controls of remote command, which are not described because they are known and do not affect the scope of this invention.

As it was previously explained, the swing (P) hangs from the lift cart, called in that way because it also bears a plurality of arched bars (14) that hang from a longiform tube (19) threaded in the holes (10) defined on the free ends of each incurved arm (8) and (8′).

In the exposed conditions, the presence of said longiform tube (19), confers to the nurse the possibility of choosing the number of hangers to be used in every case, which, undoubtedly, is in function to the physical contexture of each patient.

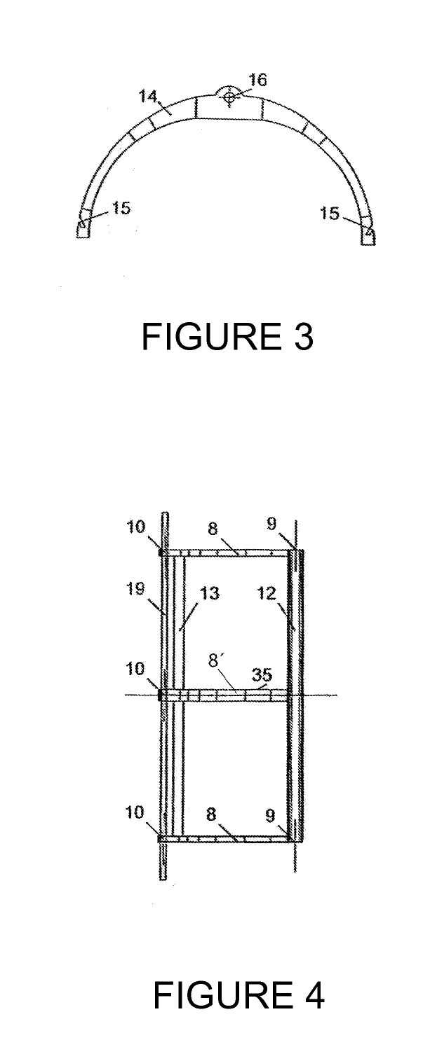

As it is particularly shown in FIG. 3, in preferred embodiments, each hanger (14) comprises an arch with circumference with a midpoint that includes a corresponding hole (16) provided for its bascule mounting on the mentioned longiform tube (19) (visible in FIG. 4). Each hanger includes on its free ends on the external side and at a 45° angle a tally where the handles of the bed pad (18) fit, the bed pad receptor of the patient (represented with a discontinuous line).

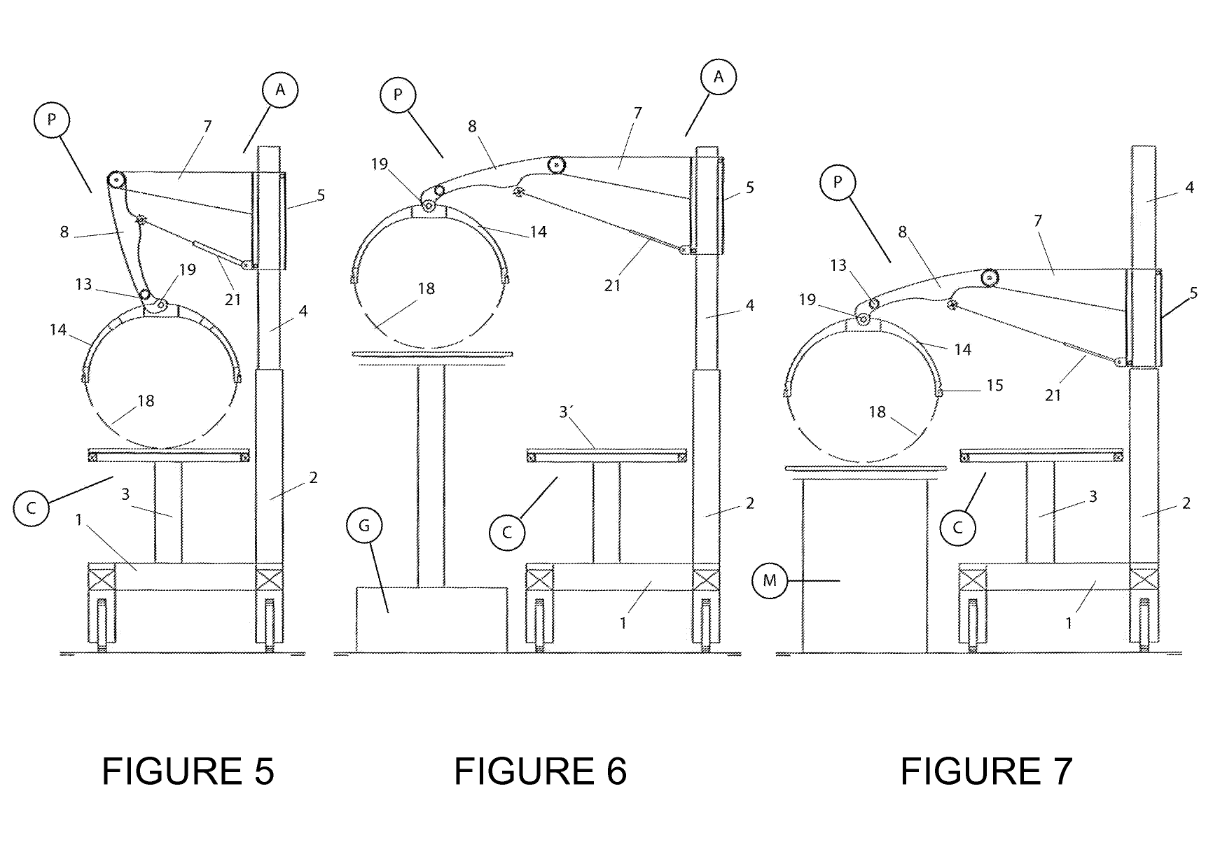

In this way, constituted the assembly and as is especially represented in FIGS. 5 to 7, it is possible to understand that it is about a strong vehicle and maneuverability capable of displacing smoothly and silently along hospital floors and going through openings and entrance doors to rooms, entering lifts and displacing comfortably along the halls of the hospital, keeping the patient rocked and contained by the bed pad (18) and lying on resting situation over the stretcher (C).

To perform the transfer tasks the actuators (20) and (21) are used and they could be pneumatic cylinders or the equivalent. With the cylinder (20) the lift cart (A) is displaced, while with the actuator (21) transversal movements of the swing (P) are produced, necessary for the lateral transfers.

In the exposed manner, when the patient is in his bed (M), the nurse can place the bed pad, and then proceed as follows:
1. As is shown in FIG. 7, the lift cart (A) descends and the swing (P) is displaced to the outside to dispose the hangers (14) over the bed (M) in such a way that, the same nurse proceeds to place the perimeter handles of the bed pad (18) on the tallies (15) of each hanger.
2. As it is shown in FIG. 5, once the patient is adequately positioned and located on the bed pad (18), the same nurse, using the remote control, commands the ascending displacement of the lift cart (A) lifting the patient.
3. Simultaneously, as it is shown in FIG. 5, the same nurse, using the remote control, laterally displaces the swing (P) until the patient is opposing at level and deposited smoothly on the stretcher (C) of the invented vehicle;
4. As it is shown in FIG. 5, the patient, lying on stretcher (C) and contained by the bed pad (18) that is still boned to the set of hangers (14), can be transported by the interior of the hospital towards where transport is required for treatment.
5. FIG. 6 shows the case where the patient is transferred to a surgery table (G) which, usually is higher than the stretcher (C), in which case the same nurse, using the referred remote control, conducts the lifting and lateral displacement maneuver until the patient is disposed on said surgery table (G).

We are in condition to ensure that the assembly in its plurality of all the constitutive parts of the vehicle when actuated from the command conform a system that integrates movements and displacements with respect to the patient especially ideal for logistics of hospital wards.

1. INTRAHOSPITAL VEHICLE FOR TRANSPORTING AND MOVING PROSTRATED PATIENTS, especially conceived for taking the hospitalized patient, usually in supine position, lift him and dispose him on a stretcher (C), to move him through hospital, with the ability to transfer him to a work table, of the type used at diagnostic services, or to an operating table (G), or its equivalent, without demand of effort for the nurse who drives it; which is constituted on a lower chassis (1) mounted over wheels (11), wherefrom a fixed stretcher (C) and a fixed stretcher frame along which a lift cart (A) displaces, vertically, bearer at least of a pair of parallel brackets (7) that are projected towards the same side, which support the swing (P) of the vehicle, constituted by a longitudinal rigid pipe (12) mounted in rotatory condition over the free ends of the mentioned brackets (7), of which at least two incurved arms (8) are supportive that, by their free ends support a longitudinal rigid bar (19) from which a plurality of hangers (14) hang bearers of attachment means for the removable placement of a bed pad; the lift cart is associated to a first actuator mounted on the fixed stretcher frame, that actuates its vertical displacements, controlled by a remote control; while the incurved central arm is associated to a second actuator mounted on the lift cart, which actuates lateral transversal movements of the swing, controlled by the same remote control.

2. INTRAHOSPITAL VEHICLE FOR TRANSPORTING AND MOVING PROSTRATED PATIENTS, according to claim 1, wherein the lower chassis (1) is constituted by a pair of crossbars joined by crossbars defining a lower rectangular structure with width and length such as the one of a conventional hospital stretcher; from one of its superior sides, a fixed stretcher frame is projected comprising the pair of vertical towers, joined together by an inferior crossbar (23), superior stretch (4) whereby the lift cart (A) moves, while it laterally contains a central column (3) of minor height that supports the stretcher (C).

3. INTRAHOSPITAL VEHICLE FOR TRANSPORTING AND MOVING PROSTRATED PATIENTS, according to claim 2 wherein said lift cart (A) comprises two robust boxes (5) that slide along the superior stretch (4) of both towers, with the insertion of corresponding glide runners or linear bearings (25); both square boxes are joined together by the structural crossbar (6) wherefrom the respective fixed brackets (7) project oriented to a side, over the stretcher (C).

4. INTRAHOSPITAL VEHICLE FOR TRANSPORTING AND MOVING PROSTRATED PATIENTS, according to claim 1, wherein the electro mechanic actuator (20) that actuates the vertical displacements of the lift cart (A), extends through an inferior crossbar (23) of the fixed stretcher frame, and a superior crossbar (6) of the lift cart (A), commanded vi a remote control.

5. INTRAHOSPITAL VEHICLE FOR TRANSPORTING AND MOVING PROSTRATED PATIENTS, according to claim 1, wherein the swing (P) comprises two incurved arms (8) that are articulately linked to the brackets (7) of the lift cart, which are joined together through a superior longitudinal pipe (12) and an inferior longitudinal pipe (13), configuring a structural grate of the swing.

6. INTRAHOSPITAL VEHICLE FOR TRANSPORTING AND MOVING PROSTRATED PATIENTS, according to claim 5, wherein in between the incurved arms of the swing, a third incurved arm (8′) is placed equidistant from the before mentioned, which serves as anchor to the cylinder (21), on its point (35).

7. INTRAHOSPITAL VEHICLE FOR TRANSPORTING AND MOVING PROSTRATED PATIENTS, according to claim 1, wherein the transversal displacements of the swing (P) are executed through the electro mechanic actuator (21) which extends from the lift cart (A), and an intermediate point of an incurved arm, which is kept united to an electronic circuit that includes a command by remote control.

8. INTRAHOSPITAL VEHICLE FOR TRANSPORTING AND MOVING PROSTRATED PATIENTS, according to claim 1, wherein the swing (P), holds a plurality of arched bars that constitute the hangers (14) that hang from a logiform tube (19) threaded in the holes (10) defined on the free ends of each incurved arm.

9. INTRAHOSPITAL VEHICLE FOR TRANSPORTING AND MOVING PROSTRATED PATIENTS, according to claim 8, wherein each hanger (14) comprises an arch with a circumference with a midpoint that includes a corresponding hole (16) provided for its bascule mounting on the mentioned logiform tube (19), each of which on its external free ends includes tallies or grooves at 45° (15) created for mounting a bed pad (18) that receives a patient.
